(19) United States
(12) Patent Application Publication
(10) Pub. No.: US 2010/0144367 A1
(43) Pub. Date: Jun. 10, 2010

(54) METHOD FOR LOCATION DETERMINATION AND A MOBILE DEVICE

(76) Inventors: Pong Chai Goh, Singapore (SG); Yik Chye Sunny Lim, Singapore (SG)

Correspondence Address: KAUTH , POMEROY , PECK & BAILEY ,LLP, 2875 MICHELLE DRIVE, SUITE 110, IRVINE, CA, 92606, US

(21) Appl. No.: 12/531,290

(22) PCT Filed: Jan. 16, 2008
(86) PCT No.: PCT/SG08/00020

§ 371 Date: Sep. 14, 2009

(30) Foreign Application Priority Data
Mar. 15, 2007 (SG) 200701823-7

(51) Int. Cl. H04W 24/00

(52) U.S. Cl. 455/456.1

(57) ABSTRACT

A method and mobile device for location determination using sequential pattern recognition are disclosed. The method comprises determining a specific sequence of identifiers of a plurality of base transceiver stations that control cells through which a mobile device has passed when travelling along a path. The specific sequence of identifiers of a plurality of base transceiver stations are compared with a look-up table stored in a database. The look-up table comprises all possible sequence of identifiers of base transceiver stations and a location for each of the sequence of identifiers of base transceiver stations. The location of the path is determined from the comparison.

### TECHNICAL FIELD

This invention relates to a method for location determination and a mobile device and refers particularly, though not exclusively, to location of a mobile device based on base transceiver station identifiers received by the mobile device.

### REFERENCE TO RELATED APPLICATIONS

Reference is made to:
our Singapore patent application number 200605787-1 filed 28 Aug. 2006 for “Mobile Detection of a Mobile Device” (“first application”),
Singapore patent application number 200701823-7 filed 15 Mar. 2007 for “Location Determination Using Sequential Pattern Recognition” (“second application”), and
International patent application number PCT/SG2007/000209 filed 12 Jul. 2007 for “Mobile Detection of a Mobile Device” (the “PCT application”) and claiming the priority of the first application,
   the contents of which are hereby incorporated by reference as if disclosed herein in their entirety. This statement should not be taken to be an admission or suggestion that none of the first application, the second application or the PCT application is considered prior art or part of the common general knowledge under the applicable law in the state (or convention) in which the application was filed.

### DEFINITIONS

Throughout this specification a reference to

“mobile device” is to be taken as including a radio/cellular communications device, or any other device that is capable of radio/cellular communication including, but not limited to, a cellular telephone, a wireless push email device, a personal digital assistant, a computer with a wireless modem, a tablet computer, a notebook computer, a laptop computer, a media storage device, a media playback device and similar devices;

“base transceiver station” or “BTS” is to be taken as including any apparatus capable of modulating and/or demodulating a signal and transmitting and/or receiving the signal to and/or from a mobile device;

“cell” is to be taken as including the space, either in two dimensions or three dimensions, in which a given BTS is capable of transmitting a signal to and/or receiving a signal from a mobile device;

### BACKGROUND

Location technology using cellular signals have been tested in various forms. However, many prior art technologies, such as the Global System for Mobile communications (GSM), use the concept of time difference techniques. Typically prior art systems are designed to give law enforcement agencies relatively coarse location of a specific mobile phone. Such prior art systems may require significant processing at a back end server and are not adept at determining on which road the mobile phone might be travelling. Also local location determination at the mobile device itself is not currently available in commercially available devices, other than by the use of separate technology such as a Global Positioning System (GPS).

Automated taxi booking systems have been developed to provide for more efficient and fast dispatch of taxis to customers. Such systems involves huge capital investment, infrastructure, backend support systems and call centre support. They are not fully automated, i.e. they are not totally unmanned.

Taxi booking and customer allocation systems have hitherto been on the basis of using a call centre to take calls from a potential customer and then matching the potential customer against a database of available (nearest) taxis. Once an allocation is done, i.e. customer-taxi matched, the information of the customer is sent to the taxi. The taxi then proceeds to the given location of the customer.

Such a system is call-centric and requires that the location of the customer to be known and to be a fixed location, e.g. an address or location capable of being accurately described. The taxi location is derived from GPS devices on the taxi. The taxi and customer do not have direct contact, and all communication is through the call centre.

### SUMMARY

According to a first specific expression of the invention there is provided a method for location determination using sequential pattern recognition. The method comprises determining a specific sequence of identifiers of a plurality of base transceiver stations that control cells through which a mobile device has passed when travelling along a path. The specific sequence of identifiers of the plurality of base transceiver stations is compared with a look-up table stored in a database, the look-up table comprising all possible sequence of identifiers of base transceiver stations and a location for each of the sequence of identifiers of base transceiver stations. The location of the path is determined from the comparison.

All possible sequence of identifiers of base transceiver stations may be obtained by mapping all possible sequences of identifiers of base transceiver stations for each of the locations; and recording all the possible sequences of identifiers of base transceiver stations and the location of each of the possible sequence of identifiers of base transceiver stations in the database. The mapping may be at different speeds.

The specific sequence of identifiers of the plurality of base transceiver stations is for active base transceiver stations; and may be for a set of possible locations. Each location may comprise a plurality of paths, and each path may comprise a plurality of sub-paths.

A unique identifier of each of the plurality of base transceiver stations may be given to the mobile device as it enters each of the cells controlled by each of the plurality of base transceiver stations. The unique identifiers of each of the plurality of base transceiver stations may be stored sequentially in the mobile device to form the specific sequence of identifiers of the plurality of base transceiver stations. The storing may be in a manner selected from: in a SIM card of the mobile device, in a smart card of the mobile device, and in a CPU of the mobile device.

A unique identifier of the mobile device may be sent to the database by each of the plurality of base transceiver stations in the order in which their cells are entered as the mobile device moves along the path. Alternatively or additionally, the specific sequence of identifiers of each of the plurality of base transceiver stations as stored in the mobile device may be sent to the database by the mobile device. The specific sequence of identifiers of each of the plurality of base transceiver stations may be sent by a wireless connection including at least one of: SMS, MMS, and GPRS. The sending may be at preset intervals selected from: time, at regular intervals of time, at predetermined intervals of time, after a predetermined number of base transceiver station identifiers have been recorded, and when a message size is at a certain limit. The specific sequence of identifiers of each of the plurality of base transceiver stations may be determined by a server as a result of data received from one or more of the plurality of base transceiver stations.

According to a second specific expression of the invention there is provided a method for location determination using sequential pattern recognition. The method comprises determining a specific set of identifiers of a plurality of base transceiver stations that control cells in a zone in which a mobile device is located. The specific set of identifiers of the plurality of base transceiver stations is compared with a look-up table stored in a database, the look-up table comprising all possible sets of identifiers of base transceiver stations and a location for each of the sets of identifiers of base transceiver stations. A characteristic of the zone is determined from the comparison.

The characteristic of the zone may be selected from: the specific set of identifiers of the plurality of base transceiver stations, and an identifier of a location of the zone. All possible sets of identifiers of base transceiver stations are obtained by mapping all possible sets of identifiers of base transceiver stations for each of the locations; and recording all the possible sets of identifiers of base transceiver stations and the location of each of the possible sets of identifiers of base transceiver stations in the database.

The specific set of identifiers of the plurality of base transceiver stations may be for active base transceiver stations. A unique identifier of each of the plurality of base transceiver stations may be sent to the mobile device. The unique identifier of each of the plurality of base transceiver stations may be sent to the mobile device as it enters each of the cells controlled by each of the plurality of base transceiver stations. The unique identifiers of each of the plurality of base transceiver stations may be stored in the mobile device to form the specific set of identifiers of the plurality of base transceiver stations. The storing may be in a manner selected from: in a SIM card of the mobile device, in a smart card of the mobile device, and in a CPU of the mobile device.

A unique identifier of the mobile device may be sent to the database by each of the plurality of base transceiver stations in the order in which their cells are entered as the mobile device enters the zone.

The specific set of identifiers of each of the plurality of base transceiver stations as stored in the mobile device may be sent to the database by the mobile device. The specific set of identifiers of each of the plurality of base transceiver stations may be sent by a wireless connection including at least one of: SMS, MMS, and GPRS. The sending may be at preset intervals selected from: time, at regular intervals of time, at predetermined intervals of time, after a predetermined number of base transceiver station identifiers have been recorded, and when a message size is at a certain limit.

The look-up table may be used by the mobile device to translate a selected zone into a set of base transceiver identifiers. The set of base transceiver station identifiers may be set on or transferred to the mobile device. If an observed base transceiver station identifier of the mobile device is in the set of base transceiver station identifiers another application of the mobile device may be started. The zone may be used to provide caller location identification.

In a third specific expression of the invention there is provided a mobile device comprising: a memory configured to store one or more sets, each set including one or more base transceiver station identifiers, each set associated with a zone and/or location and at least one zone and/or location having two or more sets, a receiver configured to receive base transceiver station identifiers from one or more base transceiver stations within range of the mobile device, and a processor configured to determine whether the device is in a predetermined zone and/or location, and/or to determine which zone and/or location the mobile device is in, depending on the base transceiver station identifiers received by the receiver and the sets stored in the memory.

The processor may be configured to execute a program stored in the memory and/or send the determined zone and/or location to a remote device depending on whether the mobile device is determined to be in a predetermined zone and/or location. The program may include instructions to display advertising on the mobile device related to the location. The memory may be configured to store at least one set for a “home” zone and/or at least two sets for an “office” zone. The processor may be configured to send a signal to a remote device to charge based on a different tariff when the mobile device is the “home” zone and/or the “office” zone. The mobile device may further comprise a display configured to display whether the mobile device is the “home” zone and/or the “office” zone.

In a fourth specific expression of the invention there is provided a method of locating a mobile device, the method comprising receiving base transceiver station identifiers from one or more base transceiver stations within range of the mobile device, comparing the received base transceiver station identifiers to one or more sets, each set including one or more base transceiver station identifiers, each set associated with a zone and/or location, and at least one zone and/or location having two or more sets, and if there is a match, determining the location of the mobile device as the zone and/or location associated with the matching set.

The method may further comprise entering a data acquisition mode, receiving base transceiver station identifiers from one or more base transceiver stations within range of the mobile device, receiving a zone and/or location to be associated with the received base transceiver station identifiers, and storing the received base transceiver station identifiers as a set and associating the set with the zone and/or location. The data acquisition mode may be ended after a predetermined period of time or when a predetermined number of base transceiver station identifiers have been received. Each base transceiver station identifier received while in the data acquisition mode may correspond to a separate set for the received zone and/or location. Each set may include the base transceiver station identifiers received in a particular location with the zone. The method may further comprise providing instructions to a user to move to predetermined locations within the zone; and/or receiving one or more sets and associated zone and/or location from a remote device and storing the received sets and associated zone and/or location.

In a fifth specific expression of the invention there is provided a method for vehicle allocation, the method comprising a server receiving a vehicle message from mobile devices in each of all available vehicles; the server receiving a requiring vehicle message from a mobile device of a customer; the server determining all available vehicles within a predetermined range of the mobile device of the customer; the server sending a request message to the mobile devices in all available vehicles within the predetermined range of the mobile device of the customer; the server receiving an acceptance message from the mobile device of a successful one of the available vehicles; the server sending a customer message to the mobile device of the successful vehicle; and the mobile device of the successful vehicle being used to contact the mobile device of the customer.

The vehicle message may be received from a mobile device of a vehicle; the server updates the status of that vehicle as vehicle available and obtains the location of that vehicle. The status and location of that vehicle may be maintained by the server and is updated on a regular basis. The requiring vehicle message may include information related to at least one of: the mobile device of the customer, and the customer. The requiring vehicle message may be received by the server. The server may decode the information related to the mobile device of the customer and the customer, to obtain information related to the mobile device of the customer and its location. If the server receives acceptance messages from more than one of the available vehicles within the predetermined range of the mobile device of the customer, the server may send the customer message to the mobile device of the first-received acceptance and may delete the successful vehicle and/or the mobile device of the successful vehicle from a database of available vehicles. The customer message may comprise the information relating to the mobile device of the customer and the customer. The mobile device of the successful vehicle may use the information relating to the mobile device of the customer and the customer to contact the mobile device of the customer to obtain relevant details of the customer. The mobile device of the customer may be sent a notification providing details of the successful vehicle and its mobile device. The server may send rejection notifications to the mobile devices of those available vehicles that were not successful.

### BRIEF DESCRIPTION OF THE DRAWINGS

In order that the invention may be fully understood and readily put into practical effect there shall now be described by way of non-limitative example only preferred embodiments of the present invention, the description being with reference to the accompanying illustrative drawings.

In the drawings:

FIG. 1 is a schematic representation of an observed sequence of base transceiver stations in a specific direction;

FIG. 2 is a schematic representation of a number of base transceiver stations in a specific zone;

FIG. 3 is a flow chart for the operation of the exemplary embodiment of FIG. 1;

FIG. 4 is a flow chart for the operation of the exemplary embodiment of FIG. 2;

FIG. 5 is a flow chart for the operation of another exemplary embodiment;

FIGS. 6(a) and 6(b) are schematic diagrams of a mobile device according to a further exemplary embodiment;

FIG. 7 is an illustration of an application for the mobile device shown in FIG. 6;

FIG. 8 is a flow diagram of a method of location according to the further exemplary embodiment;

FIG. 9 is a system architecture diagram of a final exemplary embodiment; and

FIG. 10 is a flow chart of the operation of the final exemplary embodiment.

### DETAILED DESCRIPTION OF THE EXEMPLARY EMBODIMENTS

A first exemplary embodiment may be able to use observations on the mobile device or SIM/Smart card of the mobile device to determine the state of a mobile device, and are able to detect if the mobile device is in motion or is stationary. GSM signals may be observed on a mobile device SIM/Smartcard. The SIM/Smart card is becoming more powerful and is capable of performing limited, less CPU intensive, operations locally. For mobile devices that have a local CPU, observable parameters may be processed instantaneously on the mobile device. For mobile devices with limited processing capability, the observed parameters may be transmitted to a server for processing.

One or more exemplary embodiments may be suitable for use in location-based services such as, for example:
traffic management,
road fleet management (e.g. taxis, lorries, trucks, couriers, police, police vehicles, ambulances, fire brigade vehicles),
location advertising,
security (e.g. in cars when they are stolen),
medical alerts,
monitoring or tracking (e.g. if workers have left the office),
road-toll systems, and
employee time clock.

One or more exemplary embodiments may allow observable parameters to be translated into location information which then can be utilized for such location-based services.

One or more exemplary embodiments may:
1. be implemented as a client on a mobile device or SIM/smart card, or as an embedded application that monitors network activity and processes the information;
2. use ground survey and calibration to obtain a database of information from which locations are determined;
3. use a control application that allows settings (e.g. password protection, detection sensitivity, Internet Protocol server for communication, send messages, and so forth) to be changed wirelessly;
4. use an ancillary application that allows wireless downloads of the necessary modules to be able to implement the service; and
5. allow a backend server to implement the service in conjunction with network operators. Access to network services will be required for this to be achieved.

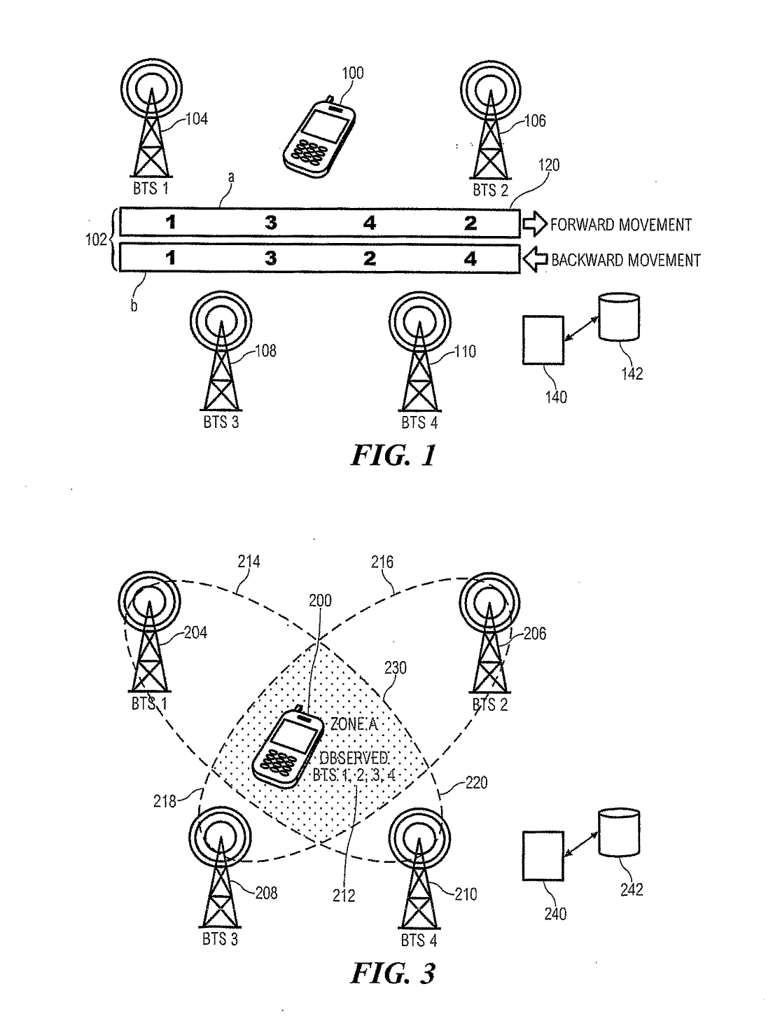

As shown in FIGS. 1 and 3, there is provided a method to identify that a mobile device 100 is moving along a particular road segment 102 according to the first exemplary embodiment. Adjacent the road segment 102 are a series of base transceiver stations: a first base transceiver station 104, a second base transceiver station 106, a third base transceiver station 108 and a fourth base transceiver station 110. Each of the base transceiver stations 104, 106, 108 and 110 has a unique identifier that is communicated to the mobile device 100 during the handshake procedure when the mobile device 100 enters the cell controlled by the respective base transceiver station. The number of base transceiver stations is not limited to four and may be any required, desired or necessary number. However, it is preferred that there be at least three to be able to provide unique sequences of base transceiver station identifiers.

This method uses the way which the mobile device 100 detects which of the base transceiver stations 104, 106, 108 and 110 is active, and how that changes, as the mobile device 100 moves along the road segment 102. As the mobile device 100 traverses the road segment 102, it traces out a sequence of active cells each of which is controlled by one of the base transceiver stations 104, 106, 108 and 110. As cells may overlap, at any one time the mobile device 100 may be in one or more active cells.

Depending on the length of the road segment 102 and the density of base transceiver stations 104, 106, 108 and 110 around the road segment 102, a unique sequence, or several possible unique sequences, of base transceiver stations may be identified for each road segment 102. The potential sequences are unique for different speeds (or lack of speed, such as when at a standstill as in traffic jams) and differs when traversing in different directions. Speed is a factor as if the area of a particular cell relevant for a specific path is quite small, there may be insufficient time for the handshake procedure to take place before the cell is exited, and thus the cell identifier will not appear in the unique sequence of cell identifiers through which the mobile device 100 has passed.

As can be seen for movement along a first path 102a in one direction (given on FIG. 1 as “forwards”) the sequence of active cells from the base transceiver stations 104, 106, 108 and 110 is 1, 3, 4, 2 representing base transceiver stations 104, 108, 110 and 106 respectively. The unique sequence means that when a similar sequence is observed, it can be determined that the mobile device 100 has traversed the segment 102. This makes the sequential pattern very useful for traffic management, and especially for road tolling.

Each of the base transceiver stations 104, 106, 108 and 110 is operatively connected to a server 140 over a telecommunications network (not shown). Also, the mobile device 100 is operatively connected to server 140 via the base transceiver stations 104, 106, 108 and 110.

The server 140 includes a database 142. Database 142 contains details of all possible sequences of base transceiver stations and their corresponding location. With the database 142 of sequences of identifiers of base transceiver stations and the possible locations for that sequence, it is possible to determine on which segment a mobile device has been or is traversing, given an observed sequence.

For a traverse on a second path b in the opposite direction (given as “backward” on FIG. 1) the resultant sequence is different: 4, 2, 3 and 1 representing base transceiver stations 110, 106, 108 and 104 respectively. This is different to the sequence in the forwards direction on path a.

In cases where a particular road segment does not have a unique sequence, it is possible to identify all the segments that have this sequence. As such, while it is not possible to determine if a particular segment has been traversed, it is possible to determine that a one of a set of possible road segments has been traversed. For example, a mobile device in a vehicle travelling on an elevated expressway and a different mobile device in a different vehicle travelling on a normal road beneath the elevated expressway may have exactly the same sequence of base transceiver stations. In such a case the sequence may be able to be used in ways that do not require a unique signature.

To establish the necessary data, each road segment to be identified is surveyed by traversing the segment in both directions to determine the cell sequence, at varying speeds, and the data recorded in server 140 and database 142 (301). For each sub-path a, b the cells that are within coverage are determined (302). The unique identifier of each of the base transceiver stations for each of the cells is also recorded (303). The possible combination of sequences is then determined (304) and the possible sets of sequences are generated (305). A check is then conducted for nearby segments to ensure that similar sequences are not observed in those nearby segments (306). If it is not possible to have a unique sequence (307), one or more additional base transceiver station may have to be erected to create the unique sequence (308). If the sequence is unique, the information is then stored in the database 142 (309).

When a mobile device 100 traverses a road segment 102 a or b (310), the unique identifier of the mobile device 100 is given to each of the base transceiver stations 104, 106, 108 and 110 during the handshake procedure as it enters the cell of the relevant base transceiving station, and the unique identifier of each of the base transceiver stations 104, 106, 108 and 110 is given to the mobile device 100 during the handshake procedure as it enters the cell of the relevant base transceiver station 104, 106, 108 and 110 (311). The sequence of identifiers of base transceiver stations 104, 106, 108 and 110 relevant for mobile device 100 as it traverses the road segment may be recorded in one or more of a number of ways:
by being recorded in the SIM/Smart card of mobile device 100, and/or in the CPU of mobile device 100 (312),
the mobile device 100 identifier is sent to the server 140 by the base transceiver stations 104, 106, 108, 110 in the order in which their cells are entered as the mobile device 100 moves along segment 102 (313).

As such, the sequence of identifiers of base transceiver stations 104, 106, 108, 110 of the mobile device 100 is:
sent to server 140 by the mobile device 100 by SMS, MMS, GPRS or any other wireless connection system (316). This may be at preset intervals determined by time (i.e. is sent at regular, predetermined intervals of time) and/or after a predetermined number of cell identifiers have been recorded and/or when the message size is at a certain limit (for example, the maximum size of an SMS message is 160 characters); or otherwise as required or desired;
   and/or
is determined by the server 140 as a result of the data received from one or more of the base transceiver stations 104, 106, 108 and 110. The base transceiver station identifier and the mobile device identifier are extracted from the received data (314) by the server 140. Other data (e.g. time) may also be extracted by server 140. In this way the server 140 records the sequence of base transceiver station identifiers by the mobile device identifier (315).

The sequence will be received at the server 140 and stored in the database 142 (317). The server 140 then determines the movement and location of the mobile device 100 based on the sequence of cell identifiers as received by it when compared with those retrieved from the database 142 (318). From the server 140 and database 142 it may be accessed when and as required by suitably authorized personnel (319).

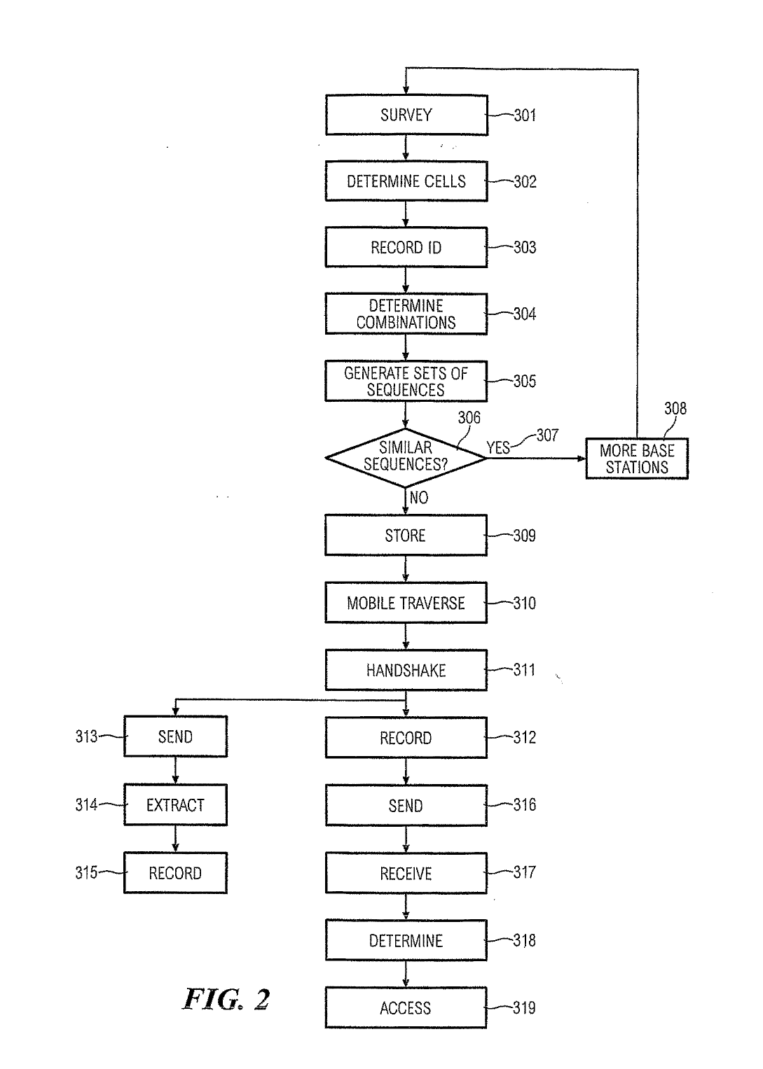

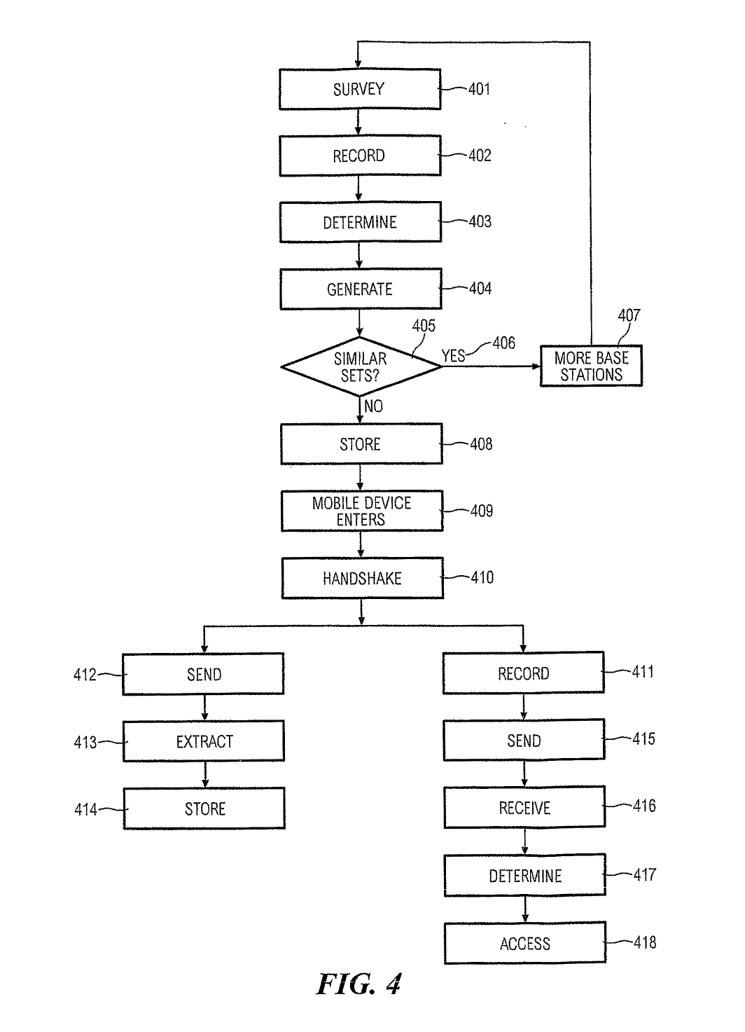

In FIG. 2 the same reference numerals are used for like components but with the prefix number changed from “1” to “2”. As shown in FIGS. 2 and 4, the method is not as effective for non-linear sequencing. For a zone such as zone 230, the sequences of identifiers of the base transceiver stations are less likely to be unique. However, a set 112 of identifiers of the base transceiver stations having a cell in which the mobile device 200 is located can be obtained. As such if a specific set 212 of base transceiver station identifiers is observed it is possible to determine that the mobile device 200 is in zone 230. The zone 230 would be significantly smaller that the size of a single cell 214, 216, 218 and 220 of the base transceiver stations 204, 206, 208, 210 respectively as the zone 230 represents the area that is common to the cells 214, 216, 218 and 220 of the observed base transceiver stations 204, 206, 208 and 210.

Again, to establish the necessary data, each zone to be identified is surveyed by traversing the zone in many directions to determine the cell sequence, at varying speeds, and the data recorded in server 240 and database 242 (401). The unique identifier of each of the base transceiver stations for each of the cells is also recorded (402). The possible combination of identifiers is then determined (403) and the possible sets of combinations are generated (404) for all locations within each zone 230. A check is then conducted for nearby zones to ensure that similar combinations are not observed in those nearby zones (405). If it is not possible to have a unique combination (406), one or more additional base transceiver station may have to be erected to create the unique combination (407). If it is a unique set, the information is then stored in the database 242 (408). It is preferable for the pattern to be unique. If the pattern is not unique, other factors or constraints may be required to ascertain the correctness of the location. For example, a check may be made of the preceding road segments and these may be used as additional keys so that uniqueness is determined. For example, a segment of interest may have a non-unique pattern 1-2-3-4. This segment can only be accessed from three other segments with patterns (5-6-7), (4-3-5) and (7-8-9). In this instance the additional preceding patterns serve as additional signatures for confirmation. New base stations may be erected to provide uniqueness if such is not available along a segment of road. This may be required for applications such as road toll collections but may not be required for other applications.

When the mobile device 200 enters the zone 230 (409), the unique identifier of the mobile device 200 is given to each of the base transceiver stations 204, 206, 208 and 210 during the handshake procedure as it enters the cell of the relevant base transceiver station 204, 206, 208 and 210 and the unique identifier of each of the base transceiver stations 204, 206, 208 and 210 is given to the mobile device 200 during the handshake procedure as it enters the cell of the relevant base transceiver station 204, 206, 208 and 210 (410). The combination of base transceiver stations 204, 206, 208 and 210 of mobile device 200 in the zone 230 may be recorded in one or more of a number of ways:
by being recorded in the SIM/Smart card of mobile device 200, and/or in the CPU of mobile device 200 (411),
the mobile device 200 identifier is sent to the server 240 by the base transceiver stations 204, 206, 208, 210 as the mobile device 200 enters the zone 230 (412).

As such, the sequence of identifiers of base transceiver stations 204, 206, 208, 210 of the mobile device 200 is:
sent to server 240 by the mobile device 200 by SMS, MMS, GPRS or any other wireless connection system (415). This may be at preset intervals determined by time (i.e. is sent at regular, predetermined intervals of time) and/or after a predetermined number of cell identifiers have been recorded and/or when the message size is at a certain limit (for example, the maximum size of an SMS message is 160 characters); or otherwise as required or desired;
and/or
is determined by the server 240 as a result of the data received from one or more of the base transceiver stations 204, 206, 208 and 210. The base transceiver station identifier and the mobile device identifier are extracted from the received data (413) by the server 240. Other data (e.g. time) may also be extracted by server 240. In this way the server 240 records the combination of base transceiver station identifiers by the mobile device identifier (414).

The sequence will be received at the server 240 and stored in the database 242 (416). The server 240 then determines the movement and location of the mobile device 200 based on the sequence of cell identifiers as received by it when compared with those retrieved from the database 242 (417). From the server 240 and database 242 it may be accessed when and as required by suitably authorized personnel (318).

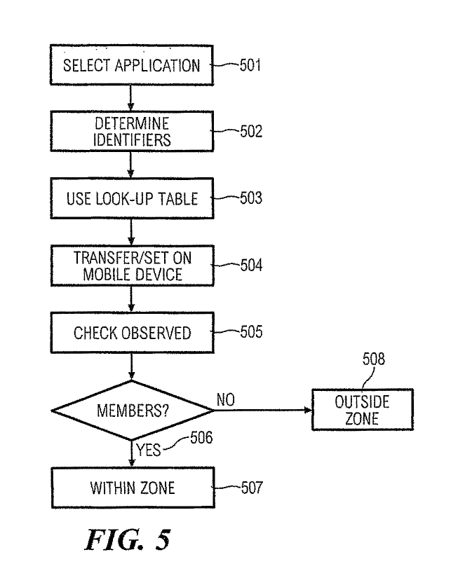

As is shown in FIG. 5, to provide a capability to make a device location-aware, for location-based service applications, it may be possible to make a device “location sensitive”. For example, the user can use a backend application (e.g. web-based application) or an application on the mobile device to the mobile device location sensitive when in a particular zone or area. After selecting the application on the mobile device (501) the identifiers of the base transceiver stations relevant for the locations are determined, (502) and a lookup table is used to translate the selected zone into a set of base transceiver stations (503). For example, a particular location may have base transceiver stations 245, 7635, 7652, 4368, 79512, 34098. The base transceiver station data set is then transferred to or set on the mobile device or its SIM card (504). The application on the mobile device checks its current observed base transceiver station against this data set (505). If it is a member of the dataset (506), the mobile device is within the selected zone (507). The dataset (i.e. set of base transceiver station identifiers and/or the identity of the zone) is information may then be used to start another application such as, for example, one that can look for promotions in the selected zone. If not a member of the dataset, it is outside the zone (508).

To provide a caller location service and/or caller location alerts, and as most mobile devices currently have a caller-identification function, the location-aware capability can be used so that a location identifier can be provided when a call is answered. For example, when answering a call to a mobile device, the mobile device responding to the call will display, for example: “John calling from CentrePoint”. Alternatively the device may divert certain calls when the mobile device is in a particular zone.

In a further exemplary embodiment location determination may take account of variation in base transceiver station identifiers observable within a given zone, such as variation according to the different floors in a multi level building. It may be desirable for example for a zone to be defined as an entire multi level building, and that a mobile device be capable of determining that it is within that zone, no matter which floor the mobile device is currently on.

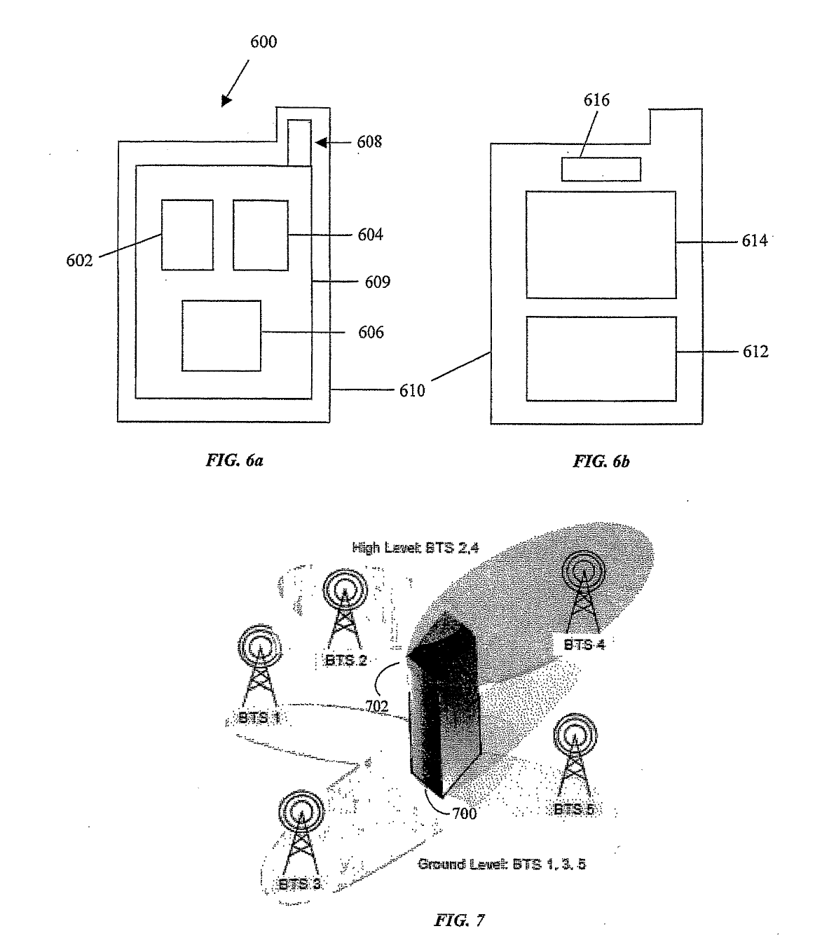

A mobile device 600 according the further exemplary embodiment is shown in FIGS. 6(a) and 6(b). The mobile device 600 includes a number of components configured to allow the mobile device to operate for its desired application. The components may include an antenna 602, a receiver 604, storage 606 and a processor 608. The components may be electrically connected on a printed circuit board 609 and located within a housing 610. A user may interact with the mobile device 600 using a keypad 612, screen 614 and audio transducer 616.

When the mobile device is within one or more cells, the antenna 602 receives radio signals from each BTS within range and converts these to an electrical signal. The electrical signal is received by the receiver 604, which demodulates the BTS identifier for each BTS within range. Each BTS identifier may be in the form of a unique alphanumeric code.

Storage 606 may store software and data. For example each of the BTS identifiers for the current location may be temporarily stored in a register and/or permanently stored in a database associated with the location. The database may be distributed e.g. it may be stored in part on the mobile device and in part on a remote storage device, wholly on the mobile device or wholly on a remote storage device. An example of storage is one or more flash memory chips.

The processor 608 may determine the location of the mobile device by running local software code or sending data to a remote device and receiving the location from the remote device. For example the processor may compare the current set of BTS identifiers stored in a register in storage 606 to a lookup table in storage. If a match occurs, the processor looks up the location associated with the matching set in the lookup table. The processor may then execute further software to determine an appropriate action depending on the location. Further actions may include displaying the location on the screen 614, sending the location to other devices and/or enable functionality appropriate to the location.

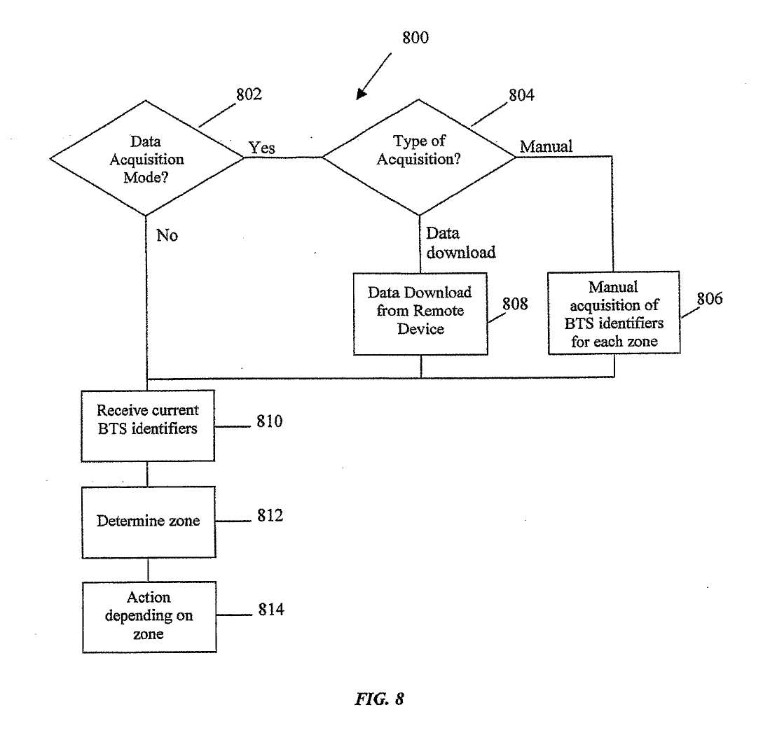

Referring to FIG. 7, it can be seen that a mobile device 600 on the ground or first floor 700, would be simultaneously within the cells for BTS 1, 3 and 5. A mobile device 600 on a high level 702 would simultaneously be within the cells for BTS 2 and 4. If it were desired to designate the entire building as zone “A”, a first set of BTS identifiers “1, 3, 5” and a second set of BTS identifiers “2, 4” would be stored and both associated with zone “A”. In this example the mobile device can accurately be located as being within zone “A”, no matter on what floor the mobile device is located on.

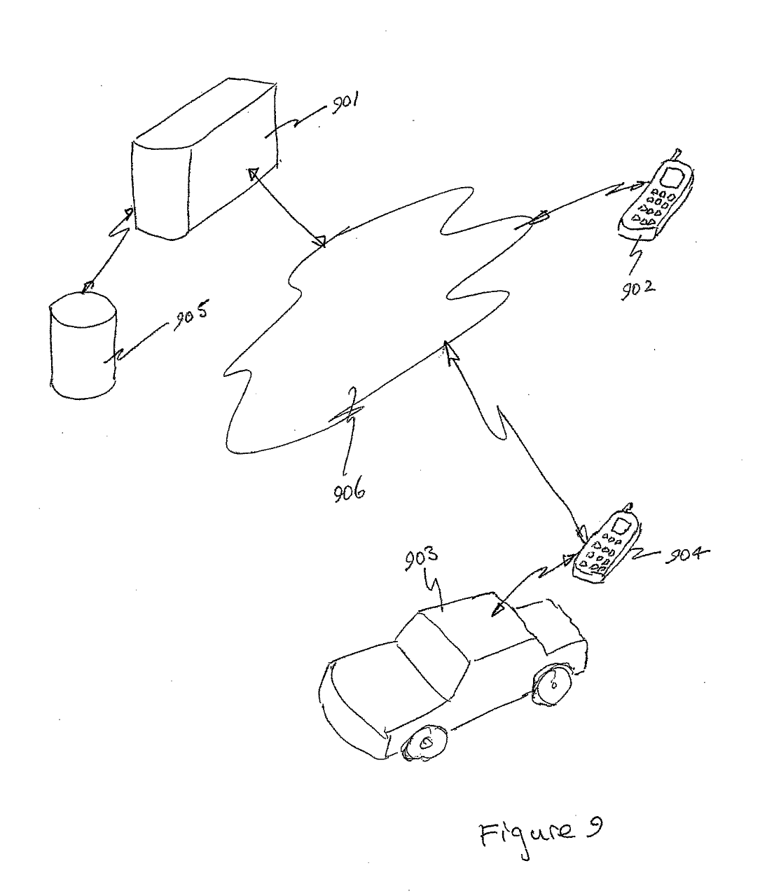

More generally the mobile device 600 in FIG. 6 may operate according to the method 800 in FIG. 8. At 802 a determination is made whether data acquisition is required. If yes, at 804 a determination is made whether the acquisition is manual or a data download. If acquisition is manual, at 806 the mobile device acquires the BTS identifiers for defined zones. If acquisition is a data download, at 808 a remote device downloads data to the mobile device.

If no further data acquisition is required, at 810 the mobile device receives the BTS identifiers for the current location. At 812 the zone of the mobile device is determined. At 814, further software may execute, depending on the zone.

Manual acquisition 806 of zone data may be implemented by setting the mobile device into manual acquisition mode, and entering the zone to be acquired. The user may be directed to go to particular locations within the zone, stay in locations for given time periods or travel across different parts of the zone. For example the screen of the device may direct a user to do an outer circuit of each floor in a building, or go to the four corners at various levels, so that all the BTS identifiers may be captured. Capturing each set may be continuous or discrete. For example each set may be the BTS identifiers captured on a particular floor over a time period or it might be the BTS identifiers captured each instant. The capture of each set, or the entire zone, may be completed after a set period of time or after a given number of BTS identifiers have been captured.

Data download 808 of zone data may be implemented by either the mobile device or a remote server initiating a data transfer. For example the zone data for advertising campaigns could be automatically download to mobile devices at regular intervals.

Zone determination 812 may be implemented depending on the requirements of the application. If the application requires high exclusivity (lower risk of falsely determining the user is inside the building when actually located outside), then each instantaneous set could be associated independently with the zone; in the example given in FIG. 7, zone “A” may be spatially described as shown in Equation (1):

{(BTS1∩BST3•BTS5)∪(BTS2∩BTS4)} (1)

where both set 1 {BTS1, BTS3, BTS5} and set 2 {BTS2, BTS4} are associated with zone “A” in the database.

If the application requires high inclusivity (lower risk of falsely determining the user is outside the building when actually located inside); in the example given in FIG. 7, zone “A” may be spatially described as shown in Equation (2):

{BTS1∪BST3∪BTS5∪BTS2∪BTS4} (2)

where set 1 {BTS1}, set 2 {BTS3}, set 3 {BTS5} set 4 {BTS2} and set 5 {BTS4} are all associated with zone “A” in the database.

Further software execution 814 may include zone based tariffs for mobile phone call or data charging. For example some network operators may wish to charge differently if a user is in a home or office zone. The home or office zone may be determined centrally by the network operator or the user may be able to define the zone themselves. Once the zone determination 812 has determined the mobile device is within the home zone, a home zone logo may be displayed on the mobile device display and an appropriate signal sent to the network operator. This may allow the wireless network operators to compete more effectively with wired network operators. Similarly location based services such as advertising for a business within a multi level building might be subsequently executed on the mobile device when the mobile device is determined to be within that building's zone.

These exemplary embodiments have application in efficient allocation of vehicles to a location. The vehicle may be, for example, a taxi, ambulance, fire vehicle, rescue vehicle, police vehicle or other emergency services vehicle. The application may be fully automated and may use location technologies on mobile devices. In this system, the vehicle and person will be put into direct contact once the allocation is made and no all centre support is required.

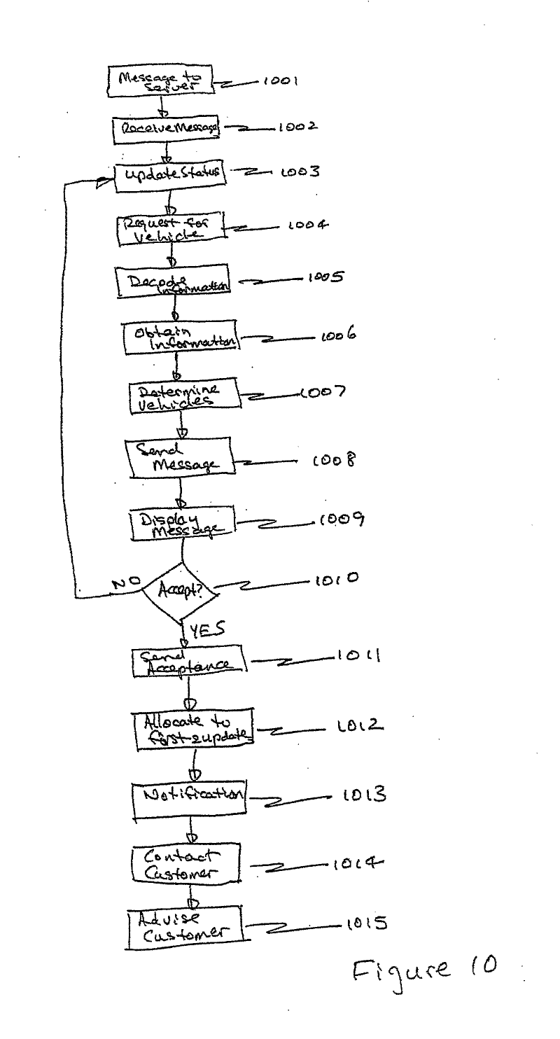

As shown in FIG. 9, there are three main components:
1. a server support system 901 with a database 905;
2. a customer mobile device 902; and
3. a vehicle 903 with a mobile device 904.

The three components 901, 902 and 904 all communicate with each other over a telecommunications network 906.

Each vehicle 903 must have a mobile device 904 such as, for example a mobile telephone. The mobile device 904 may be the mobile device of the driver of the vehicle 903. At the start of the process, vehicles 903 that are available (e.g. a taxi that is not carrying passengers) will send a message 1001 to the server 901. This may be by use of the mobile device and/or a built-in taxi system, as required or desired. The message may be sent by use of a pre-programmed button or screen function (for those with touch screens). This is a one action function, i.e. all that is required is to press a button or equivalent. The message transmits the vehicle information (e.g. number of the mobile device 904), GSM network information, and/or GPS information to the server 901. GPS may be used if available. The vehicle 903 may continue cruising or the driver may decide to stop and rest. If cruising, the vehicle 903 will continue to update the server 901 of its location and/or status at regular, predetermined intervals.

When the vehicle message is received (1002), the server updates its status as “vehicle available” (1003) and at the same time obtains the location of the vehicle 903 by any known method, including those described above. Location techniques such as GPS, Cell-ID or GprX may be used. This status and location is maintained by the server 901 and may be updated on a regular basis.

When a person requires a vehicle 903 the person uses their mobile device 902 to contact the server 901 (1004). This will automatically include information (e.g. number of the mobile device 902, GSM network information and/or GPS information) related to the mobile device and/or the person for the server 901. This may be by using a pre-programmed button or screen function on the mobile device 902 so that only one action is needed by the person and there is no need to key in complicated details. This may be by use of a simple application that can be installed in a SIM card where data streams are sent using just one SMS.

When the request is received by the server 901, the server will decode the information (1005) to obtain information related to the mobile device and its location (1006). Location techniques such as GPS, Cell-ID or GprX may be used. The server 901 then determines the number of available vehicles 903 within a predetermined range of the mobile device 902 (1007): The number may be a predetermined number or may be open. If there is location data, either from GPS or any other means such as GprX technology or sequential pattern recognition techniques, then the nearest n numbers of available vehicles are retrieved. If there is only cell-id, then the cell-id of the customer is matched with those of vacant vehicles. Otherwise, it is also possible to retrieve the vehicles with cell-ids that are near those of the customer. The server 901 then sends a request message to the mobile devices 904 in each of the vehicles 903 (1008). The request message may be sent to the nearest n vehicles via SMS or GPRS.

Mobile devices 904 receiving the request message will have the message displayed (1009). The driver of the vehicle 903 has the option to accept the request (1010). Acceptances of the requests are sent to the server 901 by each mobile device 904 (1011). The server 901 will allocate the task to the first-received acceptance and will delete the successful vehicle 903 and/or mobile device 904 from the database of available vehicles (1012). The server 901 notifies the mobile device 904 (1013), the notification including the information relating to the mobile device 902 and/or the person. With the information, the mobile device 904 is used to contact the mobile device 902 to obtain relevant details such as, for example, location (1014). At the same time, the mobile device 902 may be sent a notification providing details of the allocated vehicle, number of mobile device 904, and so forth (1015). The server 901 will also send rejection notifications to the mobile devices 904 of those vehicles 903 that were not allocated the task. As both mobile devices 902 and 904 are connected and there should be no dispute between the vehicle driver and the customer.

Priority bookings may be able to be implemented by maintaining a database 905 of priority customers (e.g. premium customers of loyalty programs such as KrisFlyer (so that only Mercedes Benz are allocated); emergency bookings; differential pricing so that those who are willing to pay extra at peak load times may bid a higher price, and advertisement messages may also be sent to mobile devices 902 by the server 901. The customer may be requested or required to enter bid fares or status information for emergency calls or loyalty program membership number using the mobile device 902.

The system may works independently of fleet operators. Even if there are multiple fleet operators, each vehicle may use the system over the system they are already using. The system is also independent of location technology and enables direct contact between the two mobile devices 902, 904.

Whilst exemplary embodiments of the present invention have been described in the foregoing description, it will be understood by those skilled in the technology concerned that many variations in details of design, construction and/or operation may be made without departing from the present invention.

1. A method for location determination using sequential pattern recognition, the method comprising:
determining a specific sequence of identifiers of a plurality of base transceiver stations that control cells through which a mobile device has passed when travelling along a path;
comparing the specific sequence of identifiers of a plurality of base transceiver stations with a look-up table stored in a database, the look-up table comprising all possible sequence of identifiers of base transceiver stations and a location for each of the sequence of identifiers of base transceiver stations; and
determining the location of the path from the comparison;
wherein the specific sequence of identifiers of each of the plurality of base transceiver stations is determined by a server as a result of data received from one or more of the plurality of base transceiver stations.

2. A method as claimed in claim 1, wherein all possible sequence of identifiers of base transceiver stations are obtained by:
mapping all possible sequences of identifiers of base transceiver stations for each of the locations;
recording all the possible sequences of identifiers of base transceiver stations and the location of each of the possible sequence of identifiers of base transceiver stations in the database; and
the mapping is at different speeds.

3. (canceled)

4. A method as claimed in claim 1, wherein the specific sequence of identifiers of a plurality of base transceiver stations is for active base transceiver stations or a set of possible locations.

5. (canceled)

6. A method as claimed in claim 1, wherein each location comprises a plurality of paths, and each path comprises a plurality of sub-paths.

7. A method as claimed in claim 1, wherein a unique identifier of each of the plurality of base transceiver stations is given to the mobile device as it enters each of the cells controlled by each of the plurality of base transceiver stations; and
the unique identifiers of each of the plurality of base transceiver stations are stored sequentially in the mobile device to form the specific sequence of identifiers of the plurality of base transceiver stations, the storing being in a manner selected from the group consisting of: in a SIM card of the mobile device, in a smart card of the mobile device, and in a CPU of the mobile device.

8. (canceled)

9. A method as claimed in claim 1, wherein a unique identifier of the mobile device is sent to the database by each of the plurality of base transceiver stations in the order in which their cells are entered as the mobile device moves along the path.

10. A method as claimed in claim 1, wherein the specific sequence of identifiers of each of the plurality of base transceiver stations as stored in the mobile device is sent to the database by the mobile device;
the specific sequence of identifiers of each of the plurality of base transceiver stations is sent by a wireless connection including at least one selected from the group consisting of: SMS, MMS, and GPRS; and
the sending is at preset intervals selected from the group consisting of: time, at regular intervals of time, at predetermined intervals of time, after a predetermined number of base transceiver station identifiers have been recorded, and when a message size is at a certain limit.

11-12. (canceled)

13. A method for location determination using sequential pattern recognition, the method comprising:
determining a specific set of identifiers of a plurality of base transceiver stations that control cells in a zone in which a mobile device is located, the set of identifiers of base transceiver station being set on or transferred to the mobile device;
comparing the specific set of identifiers of a plurality of base transceiver stations with a look-up table stored in a database, the look-up table comprising all possible sets of identifiers of base transceiver stations and a location for each of the sets of identifiers of base transceiver stations; and
determining a characteristic of the zone from the comparison.

14. A method as claimed in claim 13, wherein the characteristic of the zone is selected from the group consisting of: the specific set of identifiers of the plurality of base transceiver stations, and an identifier of a location of the zone.

15. A method as claimed in claim 13, wherein all possible sets of identifiers of base transceiver stations are obtained by:
mapping all possible sets of identifiers of base transceiver stations for each of the locations; and
recording all the possible sets of identifiers of base transceiver stations and the location of each of the possible sets of identifiers of base transceiver stations in the database.

16. A method as claimed in claim 13, wherein the specific set of identifiers of the plurality of base transceiver stations is for active base transceiver stations.

17. A method as claimed in claim 13, wherein a unique identifier of each of the plurality of base transceiver stations is sent to the mobile device;
the unique identifier of each of the plurality of base transceiver stations is sent to the mobile device as it enters each of the cells controlled by each of the plurality of base transceiver stations; and
the unique identifiers of each of the plurality of base transceiver stations are stored in the mobile device to form the specific set of identifiers of the plurality of base transceiver stations, the storing being in a manner selected from the group consisting of: in a SIM card of the mobile device, in a smart card of the mobile device, and in a CPU of the mobile device.

18.-19. (canceled)

20. A method as claimed in claim 13, wherein a unique identifier of the mobile device is sent to the database by each of the plurality of base transceiver stations in the order in which their cells are entered as the mobile device enters the zone.

21. A method as claimed in claim 13, wherein the specific set of identifiers of each of the plurality of base transceiver stations as stored in the mobile device is sent to the database by the mobile device;
the specific set of identifiers of each of the plurality of base transceiver stations is sent by a wireless connection including at least one selected from the group consisting of: SMS, MMS, and GPRS; and
the sending is at preset intervals selected from the group consisting of: time, at regular intervals of time, at predetermined intervals of time, after a predetermined number of base transceiver station identifiers have been recorded, and when a message size is at a certain limit.

22.-23. (canceled)

24. A method as claimed in claim 13, wherein the look-up table is used by the mobile device to translate a selected zone into a set of base transceiver identifiers;
if an observed base transceiver station identifier of the mobile device is in the set of base transceiver station identifiers another application of the mobile device is started; and
the zone is used to provide caller location identification.

25.-26. (canceled)

27. A mobile device comprising:
a memory configured to store one or more sets, each set including one or more base transceiver station identifiers, each set associated with a zone and/or location and at least one zone and/or location having two or more sets,
a receiver configured to receive base transceiver station identifiers from one or more base transceiver stations within range of the mobile device, and
a processor configured to determine whether the device is in a predetermined zone and/or location, and/or to determine which zone and/or location the mobile device is in, depending on the base transceiver station identifiers received by the receiver and the sets stored in the memory.

28. The mobile device claimed in claim 27 wherein the processor is configured to execute a program stored in the memory and/or send the determined zone and/or location to a remote device depending on whether the mobile device is determined to be in a predetermined zone and/or location;
the program includes instructions to display advertising on the mobile device related to the location;
the memory is configured to store at least one set for a “home” zone and/or at least two sets for an “office” zone;
the processor is configured to send a signal to a remote device to charge based on a different tariff when the mobile device is the “home” zone and/or the “office” zone; and
a display configured to display whether the mobile device is the “home” zone and/or the “office” zone.

29-32. (canceled)

33. A method of locating a mobile device comprising:
receiving base transceiver station identifiers from one or more base transceiver stations within range of the mobile device,
comparing the received base transceiver station identifiers to one or more sets, each set including one or more base transceiver station identifiers, each set associated with a zone and/or location, and at least one zone and/or location having two or more sets, each set including the base transceiver station identifiers received in a particular location with the zone; and
if there is a match, determining the location of the mobile device as the zone and/or location associated with the matching set.

34. The method as claimed in claim 33 further comprising
entering a data acquisition mode,
receiving base transceiver station identifiers from one or more base transceiver stations within range of the mobile device,
receiving a zone and/or location to be associated with the received base transceiver station identifiers, and
storing the received base transceiver station identifiers as a set and associating the set with the zone and/or location.

35. The method as claimed in claim 34 wherein the data acquisition mode is ended after a predetermined period of time or when a predetermined number of base transceiver station identifiers have been received; and
each base transceiver station identifier received while in the data acquisition mode corresponds to a separate set for the received zone and/or location.

36. (canceled)

37. The method as claimed in claim 34 further comprising providing instructions to a user to move to predetermined locations within the zone; and
receiving one or more sets and associated zone and/or location from a remote device and storing the received sets and associated zone and/or location.

38. (canceled)

39. The method of claim 1 when used for vehicle allocation, the method comprising:
a server receiving a vehicle message from mobile devices in each of all available vehicles;
the server receiving a requiring vehicle message from a mobile device of a customer;
the server determining all available vehicles within a predetermined range of the mobile device of the customer;
the server sending a request message to the mobile devices in all available vehicles within the predetermined range of the mobile device of the customer;
the server receiving an acceptance message from the mobile device of a successful one of the available vehicles;
the server sending a customer message to the mobile device of the successful vehicle; and
the mobile device of the successful vehicle being used to contact the mobile device of the customer;
wherein the determining of all available vehicles within a predetermined range of the mobile device of the customer is the method of locating a mobile device as claimed in claim 17.

40. A method as claimed in claim 39, wherein the vehicle message is received from a mobile device of a vehicle, the server updates the status of that vehicle as vehicle available and obtains the location of that vehicle;
the status and location of that vehicle is maintained by the server and is updated on a regular basis
the requiring vehicle message includes information related to at least one of: the mobile device of the customer, and the customer; and
when the requiring vehicle message is received by the server, the server decodes the information related to the mobile device of the customer and the customer, to obtain information related to the mobile device of the customer and its location.

41-43. (canceled)

44. A method as claimed in claim 39, wherein if the server receives acceptance messages from more than one of the available vehicles within the predetermined range of the mobile device of the customer, the server sends the customer message to the mobile device of the first-received acceptance and deletes the successful vehicle and/or the mobile device of the successful vehicle from a database of available vehicles;
the customer message comprises the information relating to the mobile device of the customer and the customer;
the mobile device of the successful vehicle uses the information relating to the mobile device of the customer and the customer to contact the mobile device of the customer to obtain relevant details of the customer;
the mobile device of the customer is sent a notification providing details of the successful vehicle and its mobile device; and
the server sends rejection notifications to the mobile devices of those available vehicles that were not successful.

45-48. (canceled)
